(19) United States
(12) Patent Application Publication
(10) Pub. No.: US 2008/0177633 A1
(43) Pub. Date: Jul. 24, 2008

(54) PROCESSING CHARITABLE CONTRIBUTION

(76) Inventor: Elizabeth Schaper, New York, NY (US)

Correspondence Address: PROSKAUER ROSE LLP, ONE INTERNATIONAL PLACE, BOSTON, MA, 02110, US

(21) Appl. No.: 12/016,029

(22) Filed: Jan. 17, 2008

Related U.S. Application Data
(60) Provisional application No. 60/885,445, filed on Jan. 18, 2007.

(51) Int. Cl. G06Q 20/00; G06Q 40/00

(52) U.S. Cl. 705/17; 705/39; 705/40

(57) ABSTRACT

Among other things, generating a transaction slip associated with a transaction. The slip includes a non-contribution associated with a retail transaction, and a space for a customer to provide an amount for contribution. The slip is received from the customer. The contribution amount and non-contribution amount are identified from the slip, and a card of the customer is billed for the amounts.

### PRIORITY CLAIM

This document claims priority to provisional application 60/885,445, filed Jan. 18, 2007, the entirety of which is hereby incorporated by reference herein.

### TECHNICAL FIELD

This document relates to monetary transactions, in particular charitable contributions and retail transactions.

### BACKGROUND

Card-based monetary transactions (such as payment for goods and services by credit cards, debit cards, charge cards, stored-value cards, and the like) are prevalent in the modern marketplace. Such transactions offer a card holder a secure way to pay for any amount of goods or services conveniently, without the inconvenience or risk of carrying cash. Virtually any common monetary transaction can be implemented as a card-based transaction, including charitable contributions.

For some card-based transactions the card holder can separately specify a separate dollar amount for her card to be charged, in addition to the value of the transaction. A typical example is a transaction in which a gratuity is commonly given to a service-provider, in which the card holder can pay for the service and pay a gratuity in one transaction.

### SUMMARY

In general, in one aspect: generating a transaction slip associated with the transaction, the slip including: a non-contribution amount associated with a retail transaction, and a space for a customer to provide an amount for contribution, receiving the transaction slip from the customer; identifying a contribution amount and the non-contribution amount from the slip; and causing a card of the customer to be charged for the contribution and non-contribution amounts.

Implementations may include one or more of the following features: The sales transaction slip further includes a list of charities from which the customer may select a charitably entity to receive the contribution. The slip further includes a solicitation directed to the customer for a charitable contribution. Also including providing a solicitation for charitable contribution to a customer, in which the solicitation is not on the slip.

In another aspect: generating a transaction slip using a point-of-sale equipment, in which the transaction slip contains an entry for goods or services being purchased by a buyer and a space for the buyer to indicate an amount of a contribution to be made to a charitable entity; and processing the invoice so that (a) payment for the goods or services is made to a provider of the goods or services using the buyer's card, and (b) a contribution is made to the charitable entity in the amount specified by the buyer using the buyer's card.

In another aspect: identifying a non-charitable transaction amount; identifying a charitable contribution amount; in a single transaction, causing the contribution amount and the transaction amount to be billed to a card account.

Implementations may include one or more of the following features: The single transaction includes reading a card corresponding to the card account exactly once. Also including querying a card holder for a charitable contribution amount in response to a signal from a card sponsor.

In another aspect, a retail transaction slip includes: a description of a subtotal of a retail transaction, a solicitation for a customer to contribute to a charitable entity, and a space for the customer to specify an amount for contribution. The solicitation further includes a list of charities from which the customer may select a charity to receive the contribution.

Other aspects include other combinations of the features recited above and other features, expressed as methods, apparatus, systems, program products, and in other ways. Other features and advantages will be apparent from the description and from the claims.

### DESCRIPTION OF DRAWINGS

FIGS. 1A-D are schematic representations of exemplary transaction slips for a card-based transactions.

FIG. 2 is a flowchart for initiating a card-based transaction.

FIG. 3 is a flowchart for receiving a card-based transaction.

FIG. 4 is a block diagram for a transaction initiation system.

FIG. 5 is a block diagram for a transaction receiving system.

FIG. 6 is a block diagram for a computing device.

### DETAILED DESCRIPTION

One way to enhance a charitable entity's fundraising capacity is to efficiently reach a large number of potential contributors. Moreover, presenting a potential contributor with a convenient and secure way to donate money to the charitable entity further enhances the entity's fundraising capacity. In particular, the techniques described below allow potential contributors to be reached immediately at the point of sale of a card-based transaction.

As described more fully below, customers engaging in a card-based transaction with a vendor are presented with an opportunity to make a charitable contribution. The opportunity is presented at or near at the point of sale. For example, a printed transaction slip bearing a solicitation may be generated by a vendor. Alternatively or additionally, signage may be employed by a vendor at a retail outlet to solicit contributions.

In some implementations, the contributed moneys will be transferred from the card holder, via the bank or card sponsor, to a central fund or other charitable entity. The central fund, in turn, disburses the contributed moneys to one or more charities. Alternatively, contributed moneys may be transferred from the card holder, through the bank or card sponsor, and directly to a charity.

In what follows, reference will often be made to an amount being “charged” to a card-holder's account. This is for convenience, and is not meant to limit the techniques described below to charge cards or credit cards. Unless stated otherwise, such language is also meant to encompass debiting the account of a debit card holder, deducting an amount from the account of a stored-value card holder, etc. Similarly, although the phrase “bank” may be used below for convenience, this phrase is not meant to exclude non-bank sponsors of credit, debit, charge, or stored-value cards.

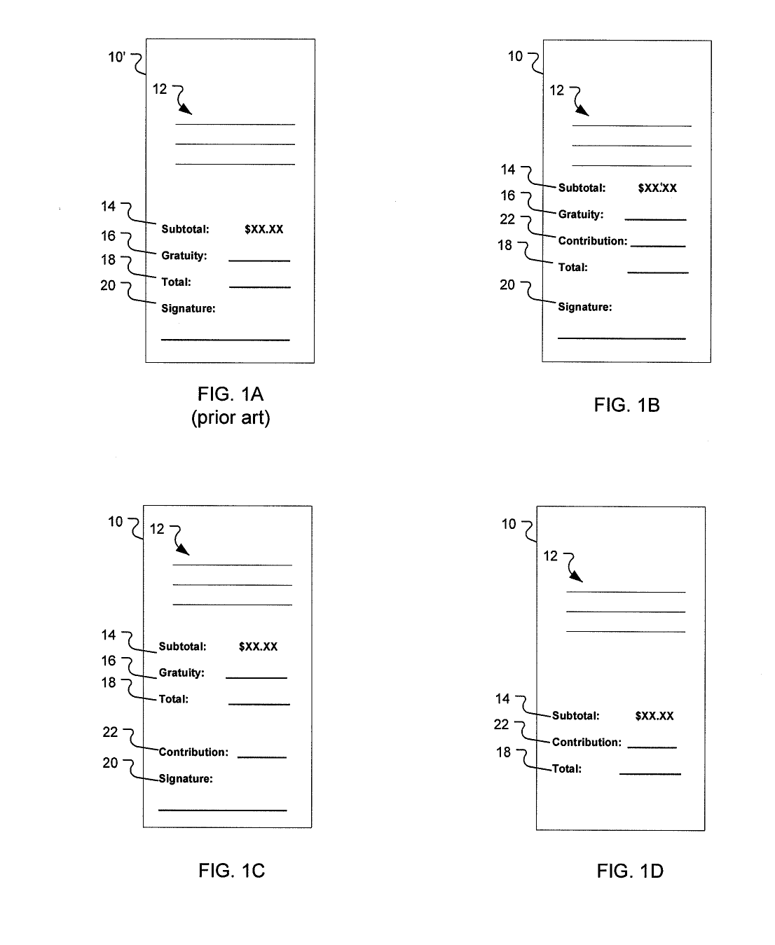

Referring to FIG. 1A, an exemplary traditional transaction slip 10′ for a card-based transaction is shown. The transaction slip 10′ includes a brief description of the transaction 12, a subtotal 14, and, optionally, a gratuity line 16 and a signature line 18, and a total line 20. The brief description 12 can convey information in any known form, such as text or graphics. Typically, the brief description 12 includes administrative information, such as a portion of the card number used in the transaction, the name and contact information of the vendor in the transaction, etc. Optionally, the brief description 12 also includes a message, such as inviting the card holder to enter a preferred-customer program or a sweepstakes.

In some implementations, the card holder fills in the gratuity line 16 and/or the total line 20 at the point of sale, and the amount reflected in the total 20 is charged to the card holder's account. That amount is subsequently transferred to the vendor in a separate transaction.

Referring now to FIGS. 1B and C, an exemplary transaction slip 10 for a card-based transaction is shown. As in the traditional transaction slip 10′, the slip 10 includes a brief description 12, subtotal 14, and optionally a gratuity line 16 and a signature line 18. The slip 10 also includes contribution line 22. The contribution line 22 may appear above the total line 18 (as in FIG. 1B), or may appear below the total line (as in FIG. 1C). One advantage for the configuration of FIG. 1C that a card holder filling out the transaction slip 10 is relieved of having to perform excessive arithmetic to arrive at a total in line 18. Optionally, the gratuity line 16 and/or signature line 18 may be omitted, as in FIG. 1D. In some implementations, the brief description 12 includes a request for the card holder to contribute to a charitable entity or charitable cause. Alternatively or additionally, such a solicitation may be made elsewhere (e.g., using signs or other media within a retail outlet.) The card holder may specify an amount of money in the contribution line 22. As described more fully below, the amount of the contribution is subsequently transferred to a charitable entity, and the subtotal and gratuity amounts are subsequently transferred to the vendor.

Solicitations of this form are easily implemented, and can reach a large number of potential contributors. Furthermore, as described below, it is relatively easy for one in the chain of commerce (e.g., a vendor or bank) to include the contribution line 22 in its transaction slips 10. Thus, this manner of solicitation can be engaged swiftly, e.g., in response to a local, national, or worldwide disaster. For example, in some implementations, to begin soliciting contributions in this manner, a bank or card company could propagate a signal to some or all of the various vendors with which it interacts, thereby causing the vendors' hardware to generate transaction slips 10 instead of transaction slips 10′. Similarly, one particular vendor could begin soliciting contributions in this manner by directly configuring its hardware to do so.

This manner of solicitation is particularly effective because, among other reasons, it reaches potential contributors at a moment when very little action is required on the contributor's part in order to make a contribution. This is in contrast with some other traditional forms of solicitation, e.g. commercial advertisements soliciting contributions to a cause. Indeed, in some implementations described below, a card holder can make a purchase and a charitable contribution in a single transaction or card swipe.

Moreover, since the contributions are being routed through the bank or card company, it is relatively easy for the bank or card company to make its own contribution based on the aggregate contributions from all or a portion of retail transactions. For example, a bank or card company desiring to match pledge contributions dollar-for-dollar can easily and rapidly identify the necessary dollar amounts.

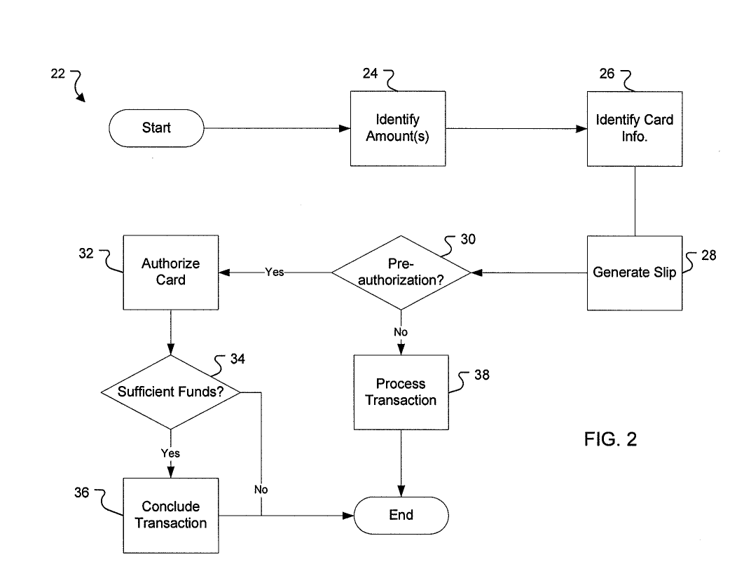

Referring to FIG. 2, a process 22 is shown for a point-of-sale implementation of card-based transactions as described above. In step 24, transaction amounts (i.e., the amounts in lines 16, 18, and 22) are identified. In step 26, card information is identified. The identified card information includes the card holder's account number, and any other security, authentication, or administrative information desired by the vendor. A transaction slip 10 is generated (step 28) and given to the card holder.

Vendors may or may not decide to pre-authorize a card for a particular amount (decision 30). For example, some vendors that typically receive or expect a gratuity may pre-authorize the card for an fixed percentage of the subtotal, e.g. 120%, to ensure the card holder can accommodate the subtotal and the gratuity. In another example, some vendors (e.g. in the automobile rental industry) that charge an hourly rate may pre-authorize an amount in excess of the anticipated fees for the rental period, to ensure the card holder can accommodate for any delay in returning the vehicle. In general, any vendor can decide to pre-authorize any amount, whether it is a constant amount, an amount based on actual or anticipated subtotals, gratuities, and/or contributions, or based on any other factor.

After attempting to authorize the card (step 32), the vendor determines whether there is a sufficient balance on the card to accommodate the authorization (step 34). If not, the transaction is declined by the bank and terminated by the vendor. If so, the transaction can be concluded at a later time (step 36). For example, if the vendor decided to pre-authorize an amount based on an anticipated gratuity and/or contribution, then the transaction can be concluded once the vendor receives the slip 10 back from the card holder and knows the actual gratuity and/or contribution made. The steps 32, 34, and 36 are considered a single transaction, despite potentially involving more than one communication with a bank or card sponsor.

If, in decision 30, the vendor does not want to pre-authorize the card for any amount, the vendor simply processes the transaction (step 38) using the information on the slip 10 received by the card holder. This includes sending the bank or company sponsoring the card the information necessary for the bank of company to adjust the card holder's balance in light of the transaction. Such information can include the information identified in steps 24 and 26, vendor-specific information (such as a vendor ID), and any other security, authentication, or other administrative information desired.

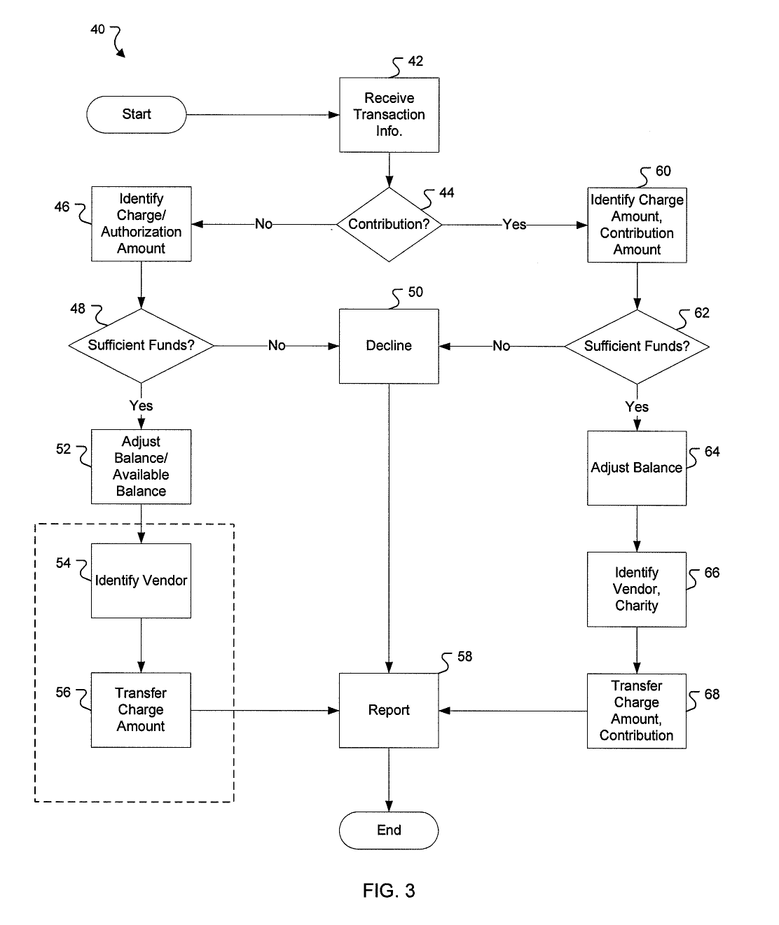

Referring to FIG. 3, a process 40 is shown for a bank or card-sponsoring company's implementation of card-based transactions as described above. In step 52, transaction information is received. Such information includes the card holder's name and account number, transaction amount(s) (i.e., the amounts in lines 16, 18, and 22 of FIG. 1B), and any other such security, authentication, or administrative information as desired. In some implementations, this includes the information sent by a vendor in step 36 of FIG. 2.

In decision 44, the transaction information is parsed to determine whether the transaction includes a nonzero contribution amount. If not, the transaction can be processed in any traditional manner. In some implementations, this includes identifying a charge amount or an authorization amount (step 46) and checking whether the account has sufficient funds to accommodate the charge or authorization (decision 48). If the account has insufficient funds, then the card is declined (step 50), and this result is reported back to the vendor (step 58). If the account has sufficient funds to accommodate the charge or authorization, then the balance or available balance, respectively, is adjusted step 52.

If the transaction is a charge, then the vendor is identified (step 52), and the charge amount is transferred to the vendor (step 54). If the transaction is merely an authorization, then steps 52 and 54 are skipped. In either case, confirmation is reported to the vendor that the transaction was successful (step 58).

If, in decision 44, the transaction includes a nonzero contribution, then the charge amount and the contribution amount are identified (step 60). It is determined whether the card holder's account has sufficient funds to accommodate both the charge amount and the contribution amount (decision 62). If not, the card is declined (step 50), and this result is reported to the vendor (step 58).

If there are sufficient funds, then the card holder's balance is adjusted by the combined charge amount and contribution amount (step 64). The vendor and the charitable entity for which the contribution is meant are identified (step 66), and the charge amount and transfer amount is transferred to the vendor and charitable entity, respectively (step 68). The successful transaction is confirmed to the vendor (step 58).

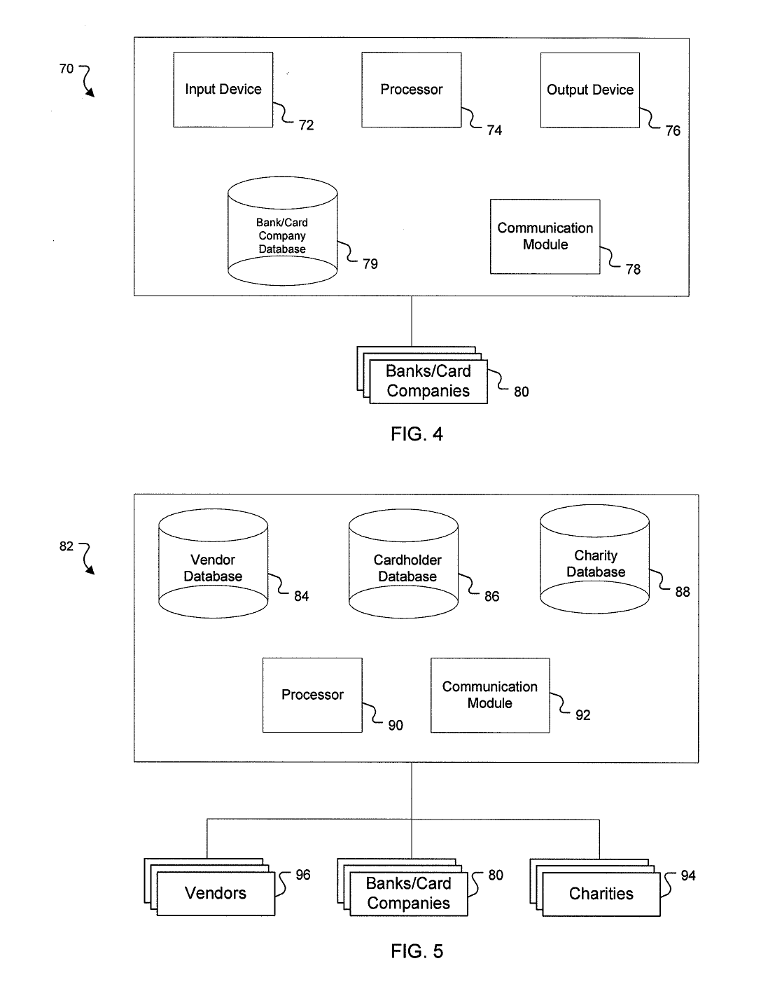

Referring to FIG. 4, a block diagram for a transaction initiation system 70 is shown. The transaction initiation system 70 includes an input device 72, a processor 74, a output device 76, a communications module 78, and a bank/card company database 79. The various components 72-79 are in mutual data communication, either directly or indirectly. Additionally, the system 70 is in data communication with one or more banks and/or card companies 80. The data communication may be implemented in any known manner, including direct physical connection, wireless connection, or connection over a communications network such as a local area network, wide area network, or the internet. All or a portion of the transaction initiation system 70 may be implemented within a vendor's point-of-sale system.

The input device 72 is operable to read or otherwise input information from a card. In some implementations, the input device 72 includes a magnetic strip reader, an RFID tag reader, a smart chip reader, an optical scanner, a keyboard, or a mouse. The input device 72 passes data to the processor 74.

The processor 74 is operable to execute instructions, including performing logical operations on data, and causing components 72-79 to perform as instructed. In particular, the processor 74 is operable to parse card data, such as described in steps 24 and 26 of FIG. 2. In some implementations, the processor 74 includes a microprocessor or an application-specific integrated circuit (“ASIC”).

The output device 76 is operable to display information to a user of the transaction initiation system 70. Such output may include the confirmation or rejection of a transaction initiated by such a user, or status information about the system 70. The output may be in any form, including audio, visual, tactile, or printed output. The output device 76 is also operable to generate transaction slips 10, as described above. In some implementations, the display includes a speaker, a video display, or a printer.

The communication module 78 is operable to implement data communication between the transaction initiation system 70 and other systems. Such communication may include transferring card information to a bank or card company, as in steps 32, 36, or 38 of FIG. 2, or receiving transaction status information from a bank or card company as is relevant to decision 34 of FIG. 2. In some implementations, the communication module includes a modem, an Ethernet card, or a wireless communication device.

The bank/card company database 79 is operable to store contact information for various banks or card companies 80 that sponsor cards accepted by the transaction initiation system 70. Such contact information can include telephone numbers, internet protocol (“IP”) addresses, physical addresses, or other contact information. The database 79 is operable to provide appropriate information to the communications module 77 for carrying out the transactions described above.

The data in database 79 can be organized in any data structure, including a list, an array, a relational database, etc. The database 79 can include any hardware capable of data storage, such as one or more magnetic or optical disks, one or more units of dynamic or static memory, etc.

Referring to FIG. 5, a block diagram for a transaction receiving system 82 is shown. The transaction receiving system 82 includes a vendor database 84, a card holder database 86, a charity database 88, a processor 90, and a communication module 92. The various components 84-92 are in mutual data communication, either directly or indirectly. Additionally, the system 82 is in data communication with one or more banks and/or card companies 80, one or more charities 94, and one or more vendors 96. The data communication may be implemented in any known manner, including direct physical connection, wireless connection, or connection over a communications network such as a local area network, wide area network, or the internet.

The vendor database 84 is operable to store contact and account information for various vendors 96 that initiate card-based transactions. Such contact information can include telephone numbers, internet protocol (“IP”) addresses, physical addresses, or other contact information. The vendor database 84 may also store financial information on each vendor 96, such as bank account numbers for disbursement of funds (e.g., in steps 56 or 68 of FIG. 3). Moreover, if any service fees are charged to the vendor for initiating card-based transactions, the vendor database 84 may also include a payment history and account information for each vendor 96.

The card holder database 86 is operable to store contact and account information for each card holder. Such contact and account information may include personal information (such as the card holder's name, address, phone number, social security number), payment history, current balance, security information, etc.

The charity database 88 is operable to store contact and account information for the various charities 94. Such contact and account information may include bank account numbers for one or more accounts of the charity (e.g., for disbursement in step 68 of FIG. 3), personnel contact information such as physical or e-mail addresses, phone numbers, telephone numbers, etc.

The data in databases 84-88 can be organized in any data structure, including a list, an array, a relational database, etc. The databases 84-88 can include any hardware capable of data storage, such as one or more magnetic or optical disks, one or more units of dynamic or static memory, etc.

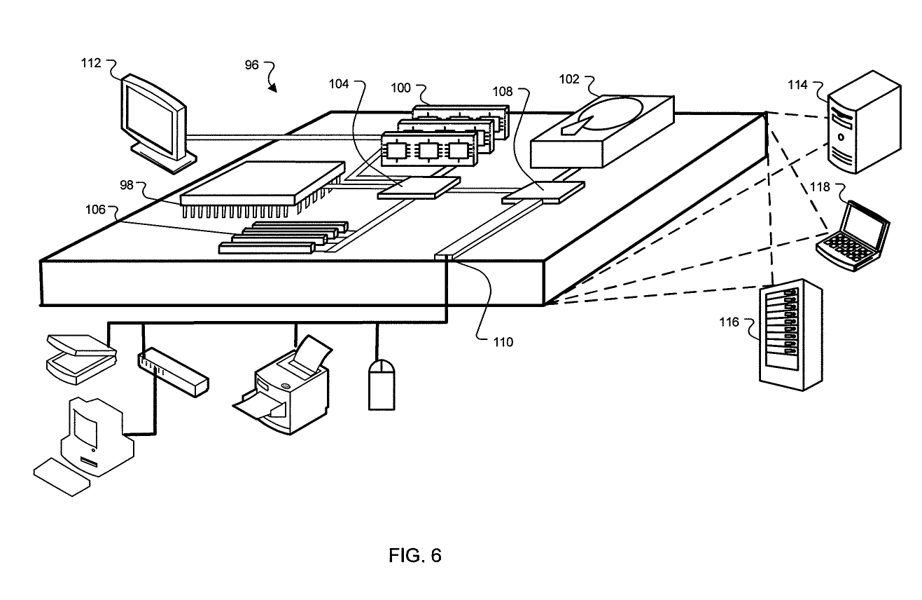

FIG. 6 is a block diagram of a computing device 96 that may be used to implement the transaction initiation or receiving systems 70, 82, as either a client or as a server or plurality of servers. Computing device 96 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 96 includes a processor 98, memory 100, a storage device 102, a high-speed interface 104 connecting to memory 100 and high-speed expansion ports 106, and a low speed interface 108 connecting to low speed bus 110 and storage device 102. Each of the components 98, 100, 102, 104, 106, and 108, are interconnected using various busses, and may be mounted on a common motherboard or in other manners as appropriate. The processor 98 can process instructions for execution within the computing device 96, including but not limited to instructions stored in the memory 100 or on the storage device 102 to display graphical information for a GUI on an external input/output device, such as display 112 coupled to high-speed interface 104. In other implementations, multiple processors and/or multiple buses may be used, as appropriate, along with multiple memories and types of memory. Also, multiple computing devices 96 may be connected, with each device providing portions of the necessary operations (e.g., as a server bank, a group of blade servers, or a multi-processor system).

The memory 100 stores information within the computing device 96. In one implementation, the memory 100 is a computer-readable medium. In one implementation, the memory 100 is a volatile memory unit or units. In another implementation, the memory 100 is a non-volatile memory unit or units.

The storage device 102 is capable of providing mass storage for the computing device 96. In one implementation, the storage device 102 is a computer-readable medium. In various different implementations, the storage device 102 may be a floppy disk device, a hard disk device, an optical disk device, or a tape device, a flash memory or other similar solid state memory device, or an array of devices, including but not limited to devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 100, the storage device 102, memory on processor 98.

The high-speed interface 104 manages bandwidth-intensive operations for the computing device 96, while the low speed interface 108 manages lower bandwidth-intensive operations. Such allocation of duties is exemplary only. In one implementation, the high-speed interface 104 is coupled to memory 100, display 112 (e.g., through a graphics processor or accelerator), and to high-speed expansion ports 106, which may accept various expansion cards (not shown). In the implementation, low speed interface 108 is coupled to storage device 102 and low speed bus 110. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 96 may be implemented in a number of different forms, as shown in the figure. For example, it may be implemented as a standard server 130, or multiple times in a group of such servers. It may also be implemented as part of a rack server system 116. In addition, it may be implemented in a personal computer such as a laptop computer 118.

Various implementations of the transaction initiation or receiving systems 70, 82 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including but not limited to at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor.

To provide for interaction with a user, the transaction initiation or receiving systems 70, 82 can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including but not limited to acoustic, speech, or tactile input.

The transaction initiation or receiving systems 70, 82 can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the transaction initiation or receiving systems 70, 82), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method comprising:
generating a transaction slip associated with the transaction, the slip including:
a non-contribution amount associated with a retail transaction, and
a space for a customer to provide an amount for contribution;
receiving the transaction slip from the customer;
identifying a contribution amount and the non-contribution amount from the slip; and
causing a card of the customer to be charged for the contribution and non-contribution amounts.

2. The method of claim 1, wherein the sales transaction slip further comprises a list of charities from which the customer may select a charitably entity to receive the contribution.

3. The method of claim 1, wherein the slip further includes a solicitation directed to the customer for a charitable contribution.

4. The method of claim 1, further comprising providing a solicitation for charitable contribution to a customer, in which the solicitation is not on the slip.

5. A method comprising:
Generating a transaction slip using a point-of-sale equipment, wherein the transaction slip contains an entry for goods or services being purchased by a buyer and a space for the buyer to indicate an amount of a contribution to be made to a charitable entity; and
processing the invoice so that (a) payment for the goods or services is made to a provider of the goods or services using the buyer's card, and (b) a contribution is made to the charitable entity in the amount specified by the buyer using the buyer's card.

6. A method comprising:
identifying a non-charitable transaction amount;
identifying a charitable contribution amount;
in a single transaction, causing the contribution amount and the transaction amount to be billed to a card account.

7. The method of claim 6, wherein the single transaction includes reading a card corresponding to the card account exactly once.

8. The method of claim 6, further comprising querying a card holder for a charitable contribution amount in response to a signal from a card sponsor.

9. A retail transaction slip comprising: a description of a subtotal of a retail transaction, a solicitation for a customer to contribute to a charitable entity, and a space for the customer to specify an amount for contribution.

10. The transaction slip of claim 8, in which the solicitation further includes a list of charities from which the customer may select a charity to receive the contribution.

11. A computer-readable medium bearing instructions that, when executed, cause a computer to:
generate a transaction slip associated with the transaction, the slip including:
a non-contribution amount associated with a retail transaction, and
a space for a customer to provide an amount for contribution.
identify a contribution amount and the non-contribution amount from the slip; and
cause a card of the customer to be charged for the contribution and non-contribution amounts.

12. The medium of claim 11, wherein the sales transaction slip further comprises a list of charities from which the customer may select a charitably entity to receive the contribution.

13. The medium of claim 11, wherein the slip further includes a solicitation directed to the customer for a charitable contribution.

14. The medium of claim 11, the instructions further causing the computer to provide a solicitation for charitable contribution to a customer, in which the solicitation is not on the slip.

15. A computer-readable medium bearing instructions that, when executed, cause a computer to:
generate a transaction slip using a point-of-sale equipment, wherein the transaction slip contains an entry for goods or services being purchased by a buyer and a space for the buyer to indicate an amount of a contribution to be made to a charitable entity; and
process the invoice so that (a) payment for the goods or services is made to a provider of the goods or services using the buyer's card, and (b) a contribution is made to the charitable entity in the amount specified by the buyer using the buyer's card.

16. A computer-readable medium bearing instructions that, when executed, cause a computer to:
identify a non-charitable transaction amount;
identify a charitable contribution amount;
in a single transaction, cause the contribution amount and the transaction amount to be billed to a card account.

17. The medium of claim 16, wherein the single transaction includes reading a card corresponding to the card account exactly once.

18. The medium of claim 16, the instructions further causing the computer to query a card holder for a charitable contribution amount in response to a signal from a card sponsor.
